(19) United States
(12) Patent Application Publication
(10) Pub. No.: US 2006/0218227 A1
(43) Pub. Date: Sep. 28, 2006

(54) Method and apparatus for enabling content provider authentication

(76) Inventor: Stephen L. Spear, Skokie, IL (US)

Correspondence Address: MOTOROLA, INC., 1303 EAST ALGONQUIN ROAD, IL01/3RD, SCHAUMBURG, IL, 60196, US

(21) Appl. No.: 10/567,005

(22) PCT Filed: Aug. 6, 2004
(86) PCT No.: PCT/US04/25692

§ 371 Date: Jan. 31, 2006

Related U.S. Application Data
(60) Provisional application No. 60/492,926, filed on Aug. 6, 2003.

(51) Int. Cl. G06F 15/16

(52) U.S. Cl. 709/203

(57) ABSTRACT

The need for enabling content providers to authenticate those given access to certain content is addressed by embodiments of the present invention. When a content delivery server (110) receives a request from user equipment (UE) (101) to subscribe to a content delivery session, the content delivery server determines whether content provider authentication is required. If it is, the content delivery server requests authentication by a content provider (120) for the UE for the session. After obtaining needed authentication parameters, the content provider indicates to the content delivery server an authentication result. The content delivery server then either denies the UE subscription request or proceeds with UE subscription based on the authentication result.

### REFERENCE(S) TO RELATED APPLICATION(S)

The present application claims priority from provisional application, Ser. No. 60/492926, entitled “METHOD AND APPARATUS FOR ENABLING CONTENT PROVIDER AUTHENTICATION,” filed Aug. 6, 2003, which is commonly owned and incorporated herein by reference in its entirety.

This application is related to a co-pending application entitled “METHOD AND APPARATUS FOR PROVIDING USER INFORMATION TO A CONTENT PROVIDER”, filed on even date herewith, and assigned to the assignee of the present application.

### FIELD OF THE INVENTION

The present invention relates generally to communication systems and, in particular, to enabling content provider authentication in communication systems.

### BACKGROUND OF THE INVENTION

The development of MBMS (Multimedia Broadcast/Multicast Service) standards for mobile communication networks will enable wireless service providers to offer multicast services to mobile communications devices. Presently, the standards provide third party content providers a means for sending multimedia content to participating devices. However, the standards do not currently allow the content providers to authenticate who is able to listen to particular content.

Instead, under the present standards scheme, it is assumed that the service provider will perform the authentication and, therefore, that the user will pay the service provider for not only the air interface charges but also for the content. Some content providers have close working relationships with the wireless service providers, allowing them to pass the burden of authentication and revenue collection to the service providers. However, it is believed that some content providers will instead want to directly control access to their content. For example, some content providers may not trust all their wireless service providers to accurately authenticate users or accurately report the number of users obtaining access to their content. Furthermore, some content providers may simply wish to avoid all the problems associated with providing user lists indicating who has access to what content to each of their service providers. Therefore, there is a need for enabling content providers to authenticate those given access to certain content.

### BRIEF DESCRIPTION OF THE DRAWINGS

FIG. 1 is a block diagram depiction of a communication system in accordance with multiple embodiments of the present invention.

FIG. 2 is a more detailed block diagram depiction of user equipment, a content provider and a content delivery server in accordance with multiple embodiments of the present invention.

FIG. 3 is a logic flow diagram of functionality performed by a content delivery server in accordance with multiple embodiments of the present invention.

FIG. 4 is a logic flow diagram of functionality performed by a content provider in accordance with multiple embodiments of the present invention.

### DETAILED DESCRIPTION OF EMBODIMENTS

The need for enabling content providers to authenticate those given access to certain content is addressed by embodiments of the present invention. When a content delivery server receives a request from user equipment (UE) to subscribe to a content delivery session, the content delivery server determines whether content provider authentication is required. If it is, the content delivery server requests authentication by a content provider for the UE for the session. After obtaining needed authentication parameters, the content provider indicates to the content delivery server an authentication result. The content delivery server then either denies the UE subscription request or proceeds with UE subscription based on the authentication result.

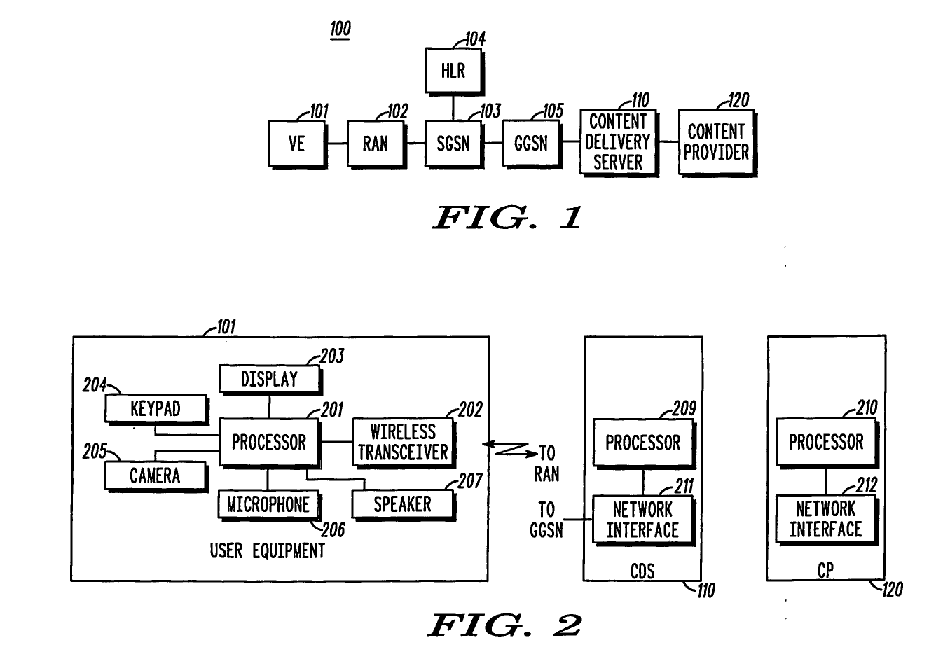

The disclosed embodiments can be more fully understood with reference to FIG. 14. FIG. 1 is a block diagram depiction of communication system 100 in accordance with multiple embodiments of the present invention. Communication system 100 is based on a 3rd Generation Partnership Project (3GPP), Multimedia Broadcast/Multicast Service (MBMS), GPRS (General Packet Radio Service) system, which is modified to implement an embodiment of the present invention. Alternative embodiments of the present invention may be implemented in communication systems that employ other technologies such as, but not limited to, Universal Mobile Telecommunications System (UMTS) technologies and Code Division Multiple Access (CDMA) technologies, including IS-2000 (1× and EV/DV) and IS-856 High Rate Packet Data (HRPD) (1× EVIDO).

Those skilled in the art will recognize that FIG. 1 does not depict all of the network equipment necessary for system 100 to operate but only those system components/logical entities particularly relevant to the description of embodiments of the present invention. For example, as illustrated in FIG. 1, communication system 100 comprises user equipment (UE) 101, radio access network (RAN) 102, Serving GPRS Support Node (SGSN) 103, home location register (HLR) 104, Gateway GPRS Support Node (GGSN) 105, content delivery server 110, and content provider 120.

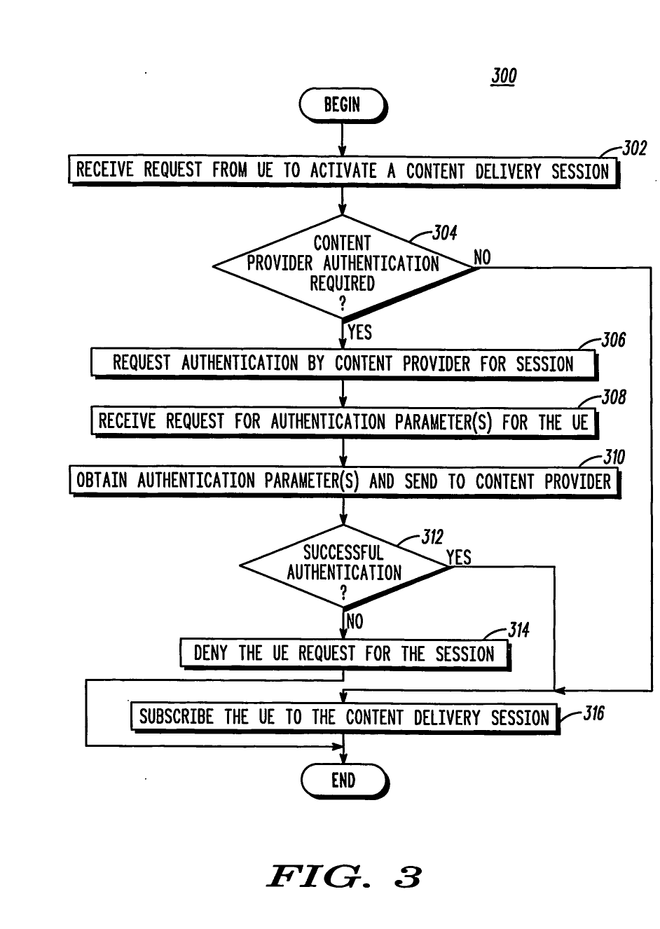

While user equipment platforms are well-known (mobile phones, computers, personal digital assistants, and gaming devices, e.g.), UE 101 is depicted in FIG. 2 as comprising processor 201, wireless transceiver 202, display 203, keypad 204, camera 205, microphone 206, and speaker 207. In general, UE logical entities such as processors, wireless transceivers, displays, keypads, cameras, speakers, and microphones are well-known. For example, processors are known to comprise basic components such as microprocessors, memory devices, and/or logic circuitry. Such components are typically adapted to implement algorithms that have otherwise been expressed logically, for example, in high-level design languages or descriptions, as computer instructions, and/or in logical flow diagrams. Thus, given an algorithm or a logic flow, those skilled in the art are aware of the many design and development techniques available to implement a processor in UE that performs the given logic.

While controller and server platforms are well-known, content delivery server 110 and content provider 120 are depicted in FIG. 2 as comprising processors 209 and 210, respectively, and network interfaces 211 and 212, respectively. In general, logical entities such as network interfaces and processors are well-known. For example, they both are known to comprise basic components such as microprocessors, memory devices, and/or logic circuitry. Thus, given an algorithm or a logic flow, those skilled in the art are aware of the many design and development techniques available to implement a processor and network interface that perform the given logic.

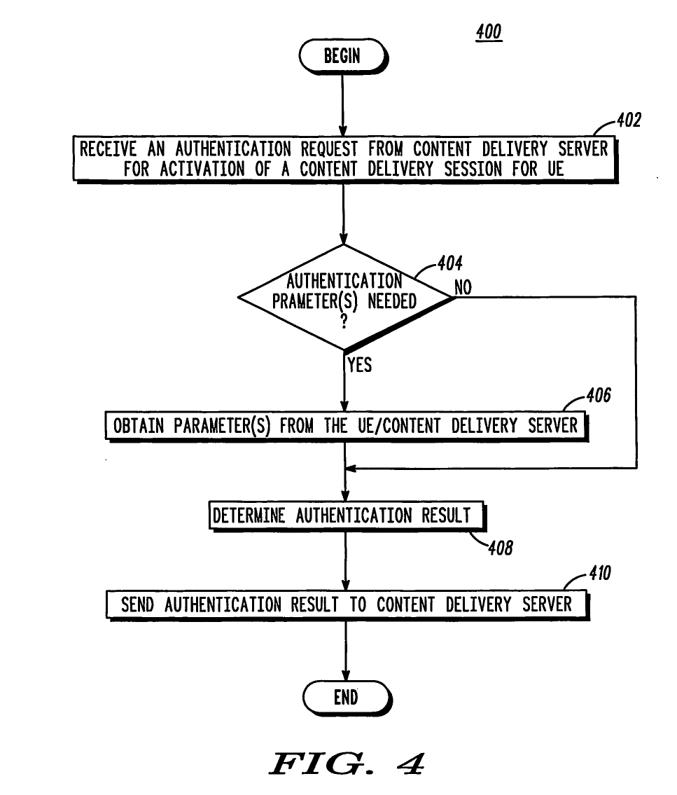

In a first embodiment of the present invention, a known content delivery server and a known content provider are adapted using known telecommunications design and development techniques to implement the content-delivery-server aspect and the content-provider aspect of the present invention. The result is content delivery server 110, which performs the method described with respect to FIG. 3, and content provider 120, which performs the method described with respect to FIG. 4. Those skilled in the art will recognize that the content-delivery-server aspect and the content-provider aspect of the present invention may each be implemented in and across various physical components of system 100 and neither are limited to single platform implementations.

In the first embodiment, content delivery server 110 provides multimedia broadcast/multicast service (MBMS) to a mobile communications network, although not all of the UE served by server 110 are necessarily mobile devices and content delivery servers, in general, need not serve mobile communications networks exclusively. In the first embodiment, content delivery server 110 performs content translation and distribution functions such as protocol translations and bearer encoding/decoding transformations. Server 110 also functions as broadcast-multicast service center (BM-SC) as described in the 3GPP MBMS specifications.

In the first embodiment, content provider 120 comprises a content server that provides content, such as multimedia programming, to the mobile communications network via content delivery server 110. Content provider 120 and server 110 communicate via a packet data network such as the Internet. Typically, although not necessarily, content provider 120 is operated by a third party, independent of the mobile communications network operator.

Operation of communication system 100, in accordance with the present invention, occurs substantially as follows. Processor 209 of content delivery server 110 receives, via network interface 211, a request from UE 101 to activate a content delivery session. While the request to activate a session may encompass starting a session, in the first embodiment, the request to activate is a request to subscribe to particular content or to join a particular multicast group. This content will then be received later when the content delivery session (or multicast session, e.g.) begins. Accordingly, the UE activation request may take the form of an Internet Group Management Protocol (IGMP) join message or, alternatively, a Multicast Listener Discovery (MLD) join message.

In response to the UE request, processor 209 determines whether content provider authentication is required to activate the content delivery session for UE 101. In the first embodiment, processor 209 maintains information for each session that it supports, including information indicating whether content provider authentication is required. When content provider authentication is required, processor 209 requests, via network interface 211, authentication. Specifically, content delivery server 110 requests authentication from content provider 120 for the UE for the content delivery session. The target of the content provider authentication is the end user (EU) of UE 101, not UE 101 itself. However, in practice it may actually be the UE supplying the authentication information (as described below). Thus, the present disclosure intends references to authentication, such as “authentication for the UE” and “authenticate the EU,” to encompass this somewhat contradictory situation.

Content provider processor 210 receives, via network interface 212, the authentication request for activating the content delivery session. In response, processor 210 performs authentication for the UE for the content delivery session. To perform this authentication of the user/UE, processor 210 uses one or more authentication parameters such as a login ID, a password, a UE identifier (such as an associated address or phone number), a user identifier (such as a name or a Social Security Number), and/or user smart card information (such as a challenge/response number for a Subscriber Identity Module (SIM) or proximity card). An authentication parameter may even include biometric information of the user such as a photo, a voice sample, a retina scan, a finger print, or a palm print.

Authentication of the user/UE may simply involve determining that UE 101 is pre-authorized for the content delivery session based on the activation request for UE 101, thereby producing a successful authentication result for UE 101. However, if UE 101 is not pre-authorized, processor 209 may send via network interface 212 a request for one or more authentication parameters to either UE 101 directly or to content delivery server 110. For example, content provider 120 may request UE 101 to prompt its user for a content provider login ID and password. Instead, when the content provider 120 requests one or more authentication parameters from content delivery server 110, server 110 may collect the requested information from various sources. For example, processor 209 may send authentication parameter requests to UE 101, RAN 102, SGSN 103, and/or HLR 104 (via SGSN 103). In response, when the one or more authentication parameters are received from the targeted entities, content delivery server 110 sends the one or more authentication parameters to content provider 120. In an alternative embodiment, content delivery server 110 may send one or more authentication parameters that are already known by server 110 with the authentication request. This would have the potential, at least, of avoiding the content provider queries in response to the session activation request.

After receiving the requested one or more authentication parameters from either content delivery server 110 or UE 101, processor 210 proceeds to determine an authentication result (by known authentication techniques) using the one or more authentication parameters received. Processor 210, via network interface 212, then sends an indication of the authentication result, to the content delivery server 110.

If the authentication result is successful, processor 209 proceeds to activate the content delivery session for the UE. Specifically, in the first embodiment, activation involves subscribing UE 101 to the content delivery session by adding UE 101 to a multicast group associated with the session. Instead, if the authentication result is failed, processor 209 denies the request to activate the content delivery session for UE 101.

FIG. 3 is a logic flow diagram of functionality performed by a content delivery server in accordance with multiple embodiments of the present invention. Logic flow 300 begins when the content delivery server receives (302) a request from user equipment (UE) to activate a content delivery session. If (304) the content delivery server determines that content provider authentication is not required to activate the session for the UE, then the content delivery server proceeds to subscribe (316) the UE to the session. However, when content provider authentication is required, the content delivery server instead requests (306) authentication for the UE for the session.

In response, the content delivery server may receive (308) a request for one or more authentication parameters for the UE from the content provider. The content delivery server obtains (310) the requested parameters and sends them to the content provider. (Although FIG. 3 illustrates the case where a request for one or more authentication parameters is received, in the case in which no such request is received (i.e., no block 308), the functionality represented by block 310 is also not performed. Therefore, logic flows directly from block 306 to 312.) When (312) the content provider indicates a successful authentication for the UE for the content delivery session, the content delivery server proceeds to subscribe (316) the UE to the session. Otherwise, the content delivery server denies (314) the UE session activation request, and logic flow 300 ends.

FIG. 4 is a logic flow diagram of functionality performed by a content provider in accordance with multiple embodiments of the present invention. Logic flow 400 begins when the content provider receives (402) an authentication request from a content delivery server for activation of a content delivery session for UE. The content provider determines whether one or more authentication parameters are needed to perform the authentication. If (404) they are needed, the content provider obtains (406) the one or more parameters from either the UE directly or from the content delivery server. If they are not needed (such as in the case of pre-authorization for the UE) or after they are obtained, the content provider proceeds with determining (408) an authentication result for the UE and indicating (410) this result to the content delivery server. Logic flow 400 thus ends.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention. In addition, those of ordinary skill in the art will appreciate that the elements in the drawings are illustrated for simplicity and clarity, and have not necessarily been drawn to scale. For example, the dimensions of some of the elements in the drawings may be exaggerated relative to other elements to help improve an understanding of the various embodiments of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

What is claimed is:

1. A method for enabling content provider authentication comprising:
receiving, by a content delivery server, a request from user equipment (UE) to activate a content delivery session;
determining, by the content delivery server, whether content provider authentication is required to activate the content delivery session for the UE;
when content provider authentication is determined to be required, requesting, by the content delivery server from the content provider, authentication for the UE for the content delivery session;
when the content provider indicates a successful authentication for the UE for the content delivery session, activating, by the content delivery server, the content delivery session for the UE.

2. The method of claim 1, wherein the content delivery server comprises a mobile communications network content delivery server.

3. The method of claim 2, wherein the mobile communications network content delivery server comprises a multimedia broadcast/multicast service (MBMS) server.

4. The method of claim 2, wherein the mobile communications network content delivery server comprises a broadcast-multicast service center (BM-SC).

5. The method of claim 1, wherein the content delivery server comprises a content translation server.

6. The method of claim 1, wherein the content delivery session comprises a multicast session.

7. The method of claim 1, wherein the request to activate the content delivery session comprises a request to receive particular content from the content provider.

8. The method of claim 1, wherein the request to activate the content delivery session comprises a request to subscribe to particular content from the content provider.

9. The method of claim 1, wherein the request to activate the content delivery session comprises a request to join a multicast group for the content delivery session.

10. The method of claim 9, wherein the request to join comprises a request from the group consisting of an Internet Group Management Protocol (IGMP) join message and a Multicast Listener Discovery (MLD) join message.

11. The method of claim 1, wherein activating the content delivery session for the UE comprises subscribing the UE to the content delivery session.

12. The method of claim 1, wherein activating the content delivery session for the UE comprises adding the UE to a multicast group for the content delivery session.

13. The method of claim 1, further comprising denying, by the content delivery server, the request from the UE to activate the content delivery session, when the content provider indicates a failed authentication for the UE for the content delivery session.

14. The method of claim 1, wherein requesting authentication for the UE for the content delivery session comprises sending at least one authentication parameter for the UE to the content provider.

15. The method of claim 14, wherein the at least one authentication parameter comprises at least one parameter from the group consisting of a login ID, a password, a UE identifier, a user identifier, smart card information, and user biometric information.

16. The method of claim 15, wherein the user biometric information comprises biometric information from the group consisting of a photo, a voice sample, a retina scan, a finger print, and a palm print.

17. The method of claim 1, further comprising:
receiving, by the content delivery server from the content provider, a request for at least one authentication parameter for the UE;
sending, by the content delivery server to the content provider, at least one authentication parameter for the UE in response to the request from the content provider.

18. The method of claim 17, further comprising:
sending, by the content delivery server, a request for at least one authentication parameter for the UE.

19. The method of claim 18, further comprising:
receiving, by the content delivery server, at least one authentication parameter for the UE from the UE.

20. The method of claim 18, further comprising:
receiving, by the content delivery server, at least one authentication parameter for the UE from a mobile communications network database.

21. A method for enabling content provider authentication comprising:
receiving, by a content provider from a content delivery server, an authentication request for activation of a content delivery session for user equipment (UE);
authenticating, by the content provider, the UE for the content delivery session to produce an authentication result;
sending, by the content provider to the content delivery server, an indication of the authentication result.

22. The method of claim 21, wherein authenticating comprises determining that the UE is pre-authorized for the content delivery session thereby producing a successful authentication result.

23. The method of claim 21, wherein authenticating comprises:
sending, by the content provider to the content delivery server, a request for at least one authentication parameter for the UE;
receiving, by the content provider from the content delivery server, at least one authentication parameter for the UE in response to the request from the content provider;
determining the authentication result using the at least one authentication parameter received from the content delivery server.

24. The method of claim 21, wherein authenticating comprises:
sending, by the content provider to the UE, a request for at least one authentication parameter;
receiving, by the content provider from the UE, at least one authentication parameter in response to the request from the content provider;
determining the authentication result using the at least one authentication parameter received from the UE.

25. A content delivery server comprising:
a network interface adapted to send and receive messaging using at least one communication protocol;
a processor, communicatively coupled to the network interface,
adapted to receive, via the network interface, a request from user equipment (UE) to activate a content delivery session,
adapted to determine whether content provider authentication is required to activate the content delivery session for the UE,
adapted to request, from the content provider via the network interface, authentication for the UE for the content delivery session, when content provider authentication is determined to be required,
adapted to activate the content delivery session for the UE, when the content provider indicates a successful authentication for the UE for the content delivery session.

26. The content delivery server of claim 25, wherein the content delivery server comprises a broadcast-multicast service center (BM-SC).

27. The content delivery server of claim 25, wherein requesting authentication for the UE for the content delivery session comprises sending, via the network interface, at least one authentication parameter for the UE to the content provider.

28. A content provider comprising:
a network interface adapted to send user content and to send and receive messaging using at least one communication protocol;
a processor, communicatively coupled to the network interface,
adapted to receive, from a content delivery server via the network interface, an authentication request for activation of a content delivery session for user equipment (UE),
adapted to authenticate the UE for the content delivery session to produce an authentication result,
adapted to send, to the content delivery server via the network interface, an indication of the authentication result.
